(19) United States
(12) Patent Application Publication
(10) Pub. No.: US 2011/0107633 A1
(43) Pub. Date: May 12, 2011

(54) ILLUMINATED SIGN WITH SUPPORTS

(76) Inventor: KERRY WELLS, Spanish Lake, MO (US)

(21) Appl. No.: 12/614,197

(22) Filed: Nov. 6, 2009

(51) Int. Cl. G09F 13/04

(52) U.S. Cl. 40/572

(57) ABSTRACT

An illuminated sign with supports has a housing, a front cover upon the housing and an opposite rear cover, hooks and spikes for mechanical securement, magnets and adhesive for physical securement, a power supply, sensors to control illumination of the sign, light sources, and various indicia upon the two covers. The front cover and the rear cover hingedly connect to the housing for access therein. Both covers also have indicia as transparent upon an opaque background. Each indicia also has its perimeter outlined in a reflective material. The housing also includes an embodiment for attachment to a vehicle. The light sources are generally light emitting diodes of a predetermined coloration. The illuminated sign hangs from inside a window, from a door, or upon a line or locates above the ground upon spikes. The sign displays a message during daylight, night, and inclement weather.

### BACKGROUND OF THE INVENTION

The illuminated sign with supports generally relates to signage and more specifically to a sign that mounts to a supporting surface by three mechanisms with controlled illumination of indicia.

For years, people have placed for sale signs in windows, secured by tape and suction cups, generally upon the interior of a building. Builders have also installed house numerals upon homes near the front door. The numerals have a color generally contrasting with the home's décor for visibility. On select homes, lighting illuminates house numerals indirectly. Signs and numerals either connect poorly to a house, such as tape in a window, or call for fixed installation.

For garage sales, political campaigns, and other causes, people often place signs in their yards or other permitted locations. The signs generally display information about an event, a slogan, a candidate, or serve as an advertisement. The signs have various metal frames and sometimes wooden is stakes for securement in an upright position upon a supporting surface, usually the ground. However, the signs, generally placards, lack direct illumination and remain dark. Select contrasting colors and certain reflective tapes provide indirect illumination particularly when a headlight casts its beam upon a sign. Without a headlight beam, most signs remain unseen during darkness and inclement weather.

### DESCRIPTION OF THE PRIOR ART

In windows and yards, and alongside sidewalks across the country, various signs advertise and promote a host of events, causes, and functions. Garage sale signs appear at street corners in spring and stay through summer. Some garage sale signs are stapled upon various utility poles and in time utilities and government agencies remove the signs. Other garage sale signs, generally poster board, have stakes behind them pounded into the ground. The poster signs generally have a short life, appearing about a week before the garage sale. The garage sale organizer then removes the signs after the sale. Signs forgotten then succumb to the elements, transforming from a rigid planar poster into a damp clump of paperboard.

When an election nears, political signs appear in yards and along roadways where permitted by ordinance and statute and also in other locations not so permitted. Political signs are generally planar poster board laminated on the printed surface. Less expensive political signs often use poster board subject to the same degradations as garage sale signs. For a simple installation of a political sign, a volunteer pounds a wooden stake into the ground and then places the political sign over the stake. Occasionally, the political sign is placed over the stake before pounding it into the ground. This leads to the sledge hammer compressing the sign material over the stake, leading the sign to slip down the stake in a few days. Other political signs install upon wire frames. The is simple wire frame is generally 3/16 inch steel wire bent into a U shape and inverted. For installation, a volunteer pushes the wire legs into the ground and then slips the sign over the frame. Installation generally calls for damp earth, that is, not hardened or stiff from a drought. A better steel frame utilizes a cooperating sign board with hollow corrugations. The frame has a generally Y shape with two uprights that insert into corrugations of the sign and two opposite, narrowly spaced legs. The legs are joined by a foot jack about four to five inches from their end. A volunteer places the sign upon the uprights, locates the sign in position, and then steps on the foot jack pushing the legs into the ground. Volunteers of limited strength have installed the foot jack frames without much trouble.

Political signs also include various bumper strips, formerly bumper stickers. The bumper strips secure to a surface, often a vehicle, using a releasable adhesive layer. The bumper strips secure to a vehicle generally during campaign season and a vehicle driver then readily removes the bumper strip by peeling a corner once the campaign ends. Though bumper strips for political purposes have been described, bumper strips have seen and still see use for displaying various slogans and sayings, often independent of politics.

The bumper strips, political signs, garage signs, and window signs though generally require external illumination to be read. Most signs can be read easily during daytime using sunlight. However, after night fall and during bad weather, the signs often escape view by drivers and passersby on foot. As mentioned previously, some signs include high contrast colors and various reflectors however, few signs suitable for home use, that is not on billboards, have illumination.

The present invention overcomes the difficulties of signs escaping visibility at night and signs with a single way of securing to a surface. The present invention provides multiple components for securement to a surface and components for direct illumination of the sign during periods of darkness as in is night or bad weather.

### SUMMARY OF THE INVENTION

Generally, the illuminated sign with supports has a rectangular housing, a front cover upon the housing and an opposite rear cover, hooks and spikes for mechanical securement of the sign, magnets and adhesive for non mechanical securement of the sign, a power supply, various sensors to control and to regulate illumination of the sign, light sources, and various indicia upon the front cover and the rear cover. The front cover and the rear cover hingedly connect to the housing and allow access therein. Both covers also have the indicia as transparent upon an opaque background. Each indicia also has its perimeter outlined in a reflective material such as tape. The housing also includes an embodiment capable of attachment to a vehicle. The light sources are generally light emitting diodes and predetermined coloration. The illuminated sign can hang from a window, door, fence rail, or other linear shape.

There has thus been outlined, rather broadly, the more important features of the invention in order that the detailed description thereof that follows may be better understood and that the present contribution to the art may be better appreciated. The present invention also includes curved hooks, pointed stakes, adhesive strips, magnetic strips, power sources including utility service, battery, and solar cells, indicia including letters, numerals, and logos, dusk to dawn sensors, an accelerometer, a manual ON/OFF switch, and an automatic OFF switch in combination with the accelerometer. Also, the LED as a light source are provided in groups of at least two diodes. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide an illuminated sign with supports that readily installs upon the ground, a building, or a vehicle.

Another object is to provide such an illuminated sign with supports that remains visible during daytime, night, and inclement weather.

Another object is to provide such an illuminated sign with supports that provides for semi-automatic control for both on/off and daylight sensing.

Another object is to provide such an illuminated sign with supports that has a low cost of manufacturing so the purchasing consumers and organizations can readily buy the illuminated sign with supports through stores and supply sources.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 is a front view of the illuminated sign constructed in accordance with the principles of the present invention;

FIG. 2 is a back view of the illuminated sign of the present invention;

FIG. 3 is a top view of the illuminated sign;

FIG. 4 is a bottom view of the illuminated sign of the present invention;

FIG. 5 is a left side view of the illuminated sign of the present invention;

FIG. 6 is a right side view of the illuminated sign;

FIG. 7 is an isometric view of the illuminated sign with covers partially open;

FIG. 8 is a front view of the invention with the cover open;

FIG. 9 is an isometric view of an alternate embodiment of the invention;

FIG. 10 is a back view of the alternate embodiment;

FIG. 11 is an exploded view of the alternate embodiment; and,

FIG. 12 is front view of another alternate embodiment.

The same reference numerals refer to the same parts throughout the various figures.

### DESCRIPTION OF THE PREFERRED EMBODIMENT

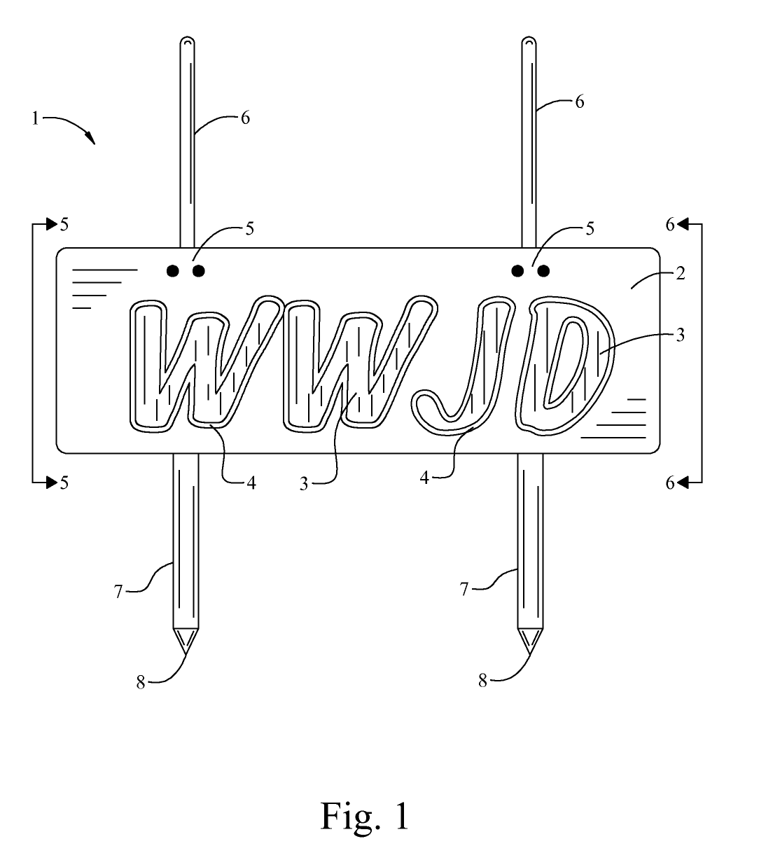

The present art overcomes the prior art limitations by providing an illuminated sign with supports. FIG. 1 shows a front view of the invention 1 in an upright orientation. The invention has a front cover 2, generally rectangular in shape with rounded corners and is generally opaque. The front cover has at least one indicia 3 thereon. Though shown as four letters in this figure, the indicia can take to form of letters, numerals, graphics, or a design. The indicia have a contrasting appearance from the remainder of the front cover, preferably yellow in color indicia upon a black in color front cover.

Though the front cover is generally opaque, the indicia 3 are generally transparent and allow light from within the invention to emanate outwardly as is later shown. As letters and numerals, the indicia have individual borders that define them. Each letter and numeral of indicia has their inherent shapes defined by a border of tape, as at 4. The tape adheres to the front cover proximate each letter and numeral without impeding their transparency. Generally the tape outlines each letter and numeral and some select graphics where appropriate. The tape is generally reflective and preferably retro reflective for both day and night visibility in the absence of internal illumination.

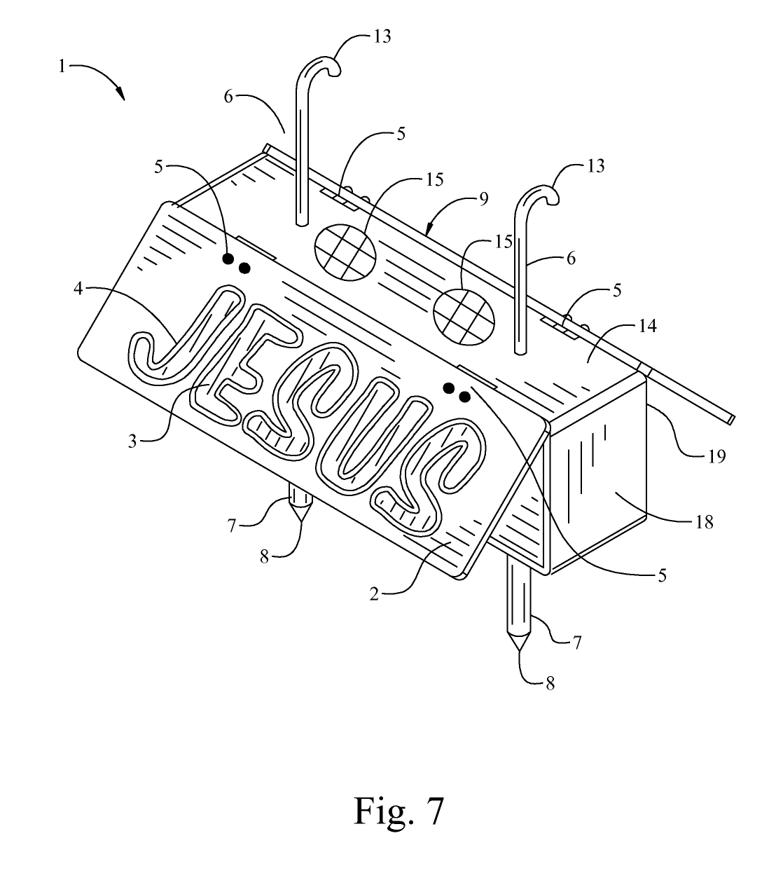

The front cover has at least one hinged connection as at 5 here shown as two hinges. The hinges denote the top of the invention and the indicia are located below the hinges, generally centered upon the front cover. The hinges connect to a housing, later shown in FIG. 7, behind the front cover. Moving outwardly from the hinges, the invention attains its upright orientation using at least one hook 6, here shown as two spaced apart hooks proximate each hinge. The hooks have a generally elongated form and extend perpendicular to the front cover, that is, outwardly from the top of the invention. The hooks as shown allow installation of the invention as suspended from inside of a window, upon a door, or hanging along a line or fence rail.

The present invention also allows installation upright upon the ground proximate a building. Opposite the hooks, the invention has at least one spike 7, here shown as two spaced apart spikes generally below the hinges. The spikes extend outwardly from the invention, generally opposite the hooks. The spikes connect to the invention at the bottom, opposite the top. Each spike is generally elongated and has a length sufficient for embedding into the ground while allowing the invention clearance above the ground. A spike is approximately six to twenty four inches in length, preferably eighteen inches. Opposite the front cover, each spike has a tip 8 that eases embedment into the ground during installation. Preferably, the tip has a conical shape with an apex opposite the remainder of the spike.

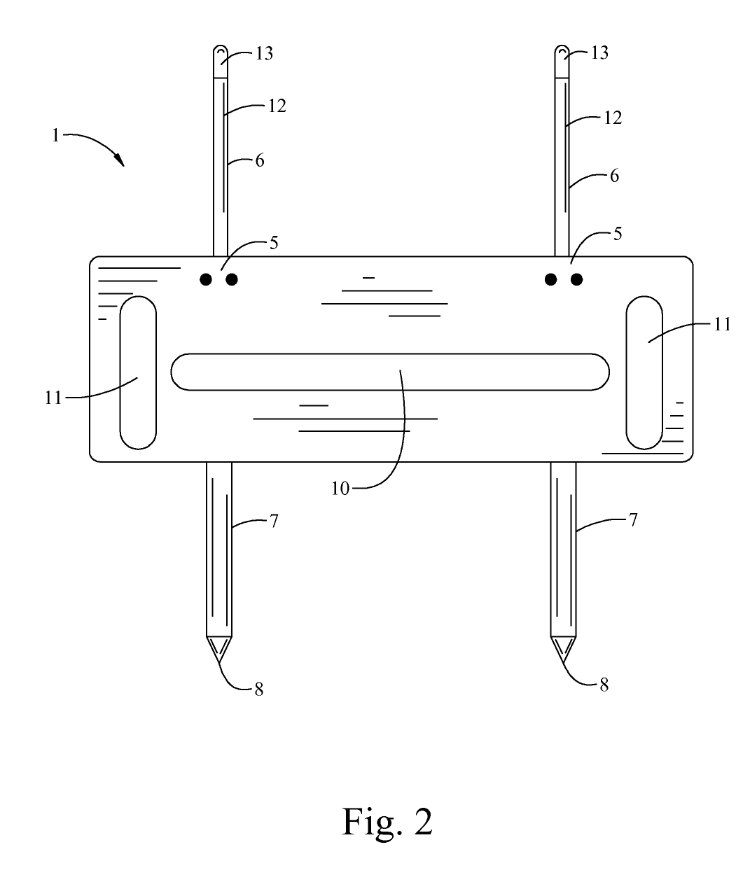

Turning the invention, FIG. 2 shows a rear view of the invention in an upright orientation. The invention 1 has its rear cover 9, generally opaque and rectangular in shape with rounded corners. The rear cover is generally spaced apart from the front cover when closed upon the housing of the invention as shown in this figure. The rear cover does not have any indicia thereon. The rear cover though has at least one horizontal strip 10 and at least one vertical strip 11 that secure the rear cover to another surface such as a building or a vehicle. Preferably, the rear cover has two vertical strips, mutually parallel and spaced apart with the horizontal strip between them as shown. In the preferred embodiment, the horizontal strip and the vertical strips include an adhesive with a release layer thereon. The adhesive binds to wood and masonry after a user removes the release layer at the time of installation. In an alternate embodiment, the vertical strips and the horizontal strips utilize strips of magnetic material affixed to the rear cover and with sufficient strength to support the weight of the invention from a ferrous metal surface, such as a vehicle body panel or bumper. The sizes of the vertical and horizontal strips can be adjusted in this alternate embodiment to provide a strong enough magnetic force.

The rear cover also has at least one hinged connection, as at 5, here shown as two hinges and generally opposite those hinges for the front cover. As before, the hinges denote the top of the invention and the indicia are located below the hinges, generally centered upon the front cover. The hinges connect to a housing, later shown in FIG. 7, behind the rear cover, that is, between the rear cover and the front cover. Moving outwardly from the hinges, the invention attains its upright orientation using at least one hook 6, preferably two spaced apart hooks proximate each hinge. The hooks have a generally elongated form, as at a shank 12, and extend perpendicular to the rear cover, that is, outwardly from the top of the invention. The hooks each have a rounded bight 13 extending outwardly from the shank forming a J shape. The bights of the hooks allow is installation of the invention as suspended from inside of a window, on the front of a door, or hanging along a line or fence rail with the bights over the line or fence.

As above, the invention also installs upright upon the ground proximate a building. Opposite the hooks, the invention has at least one spike 7, here shown as two spaced apart spikes generally below the hinges. The spikes extend outwardly from the invention, generally opposite the hooks. The spikes connect to the invention at the bottom, opposite the top. Each spike is generally elongated and has a length sufficient for embedding into the ground while allowing the invention clearance above the ground. A spike is approximately six to twenty four inches in length, preferably about eighteen inches ion length. Opposite the front cover, each spike has a tip 8 that eases embedment into the ground during installation. Preferably, the tip has a conical shape with an apex opposite the remainder of the spike.

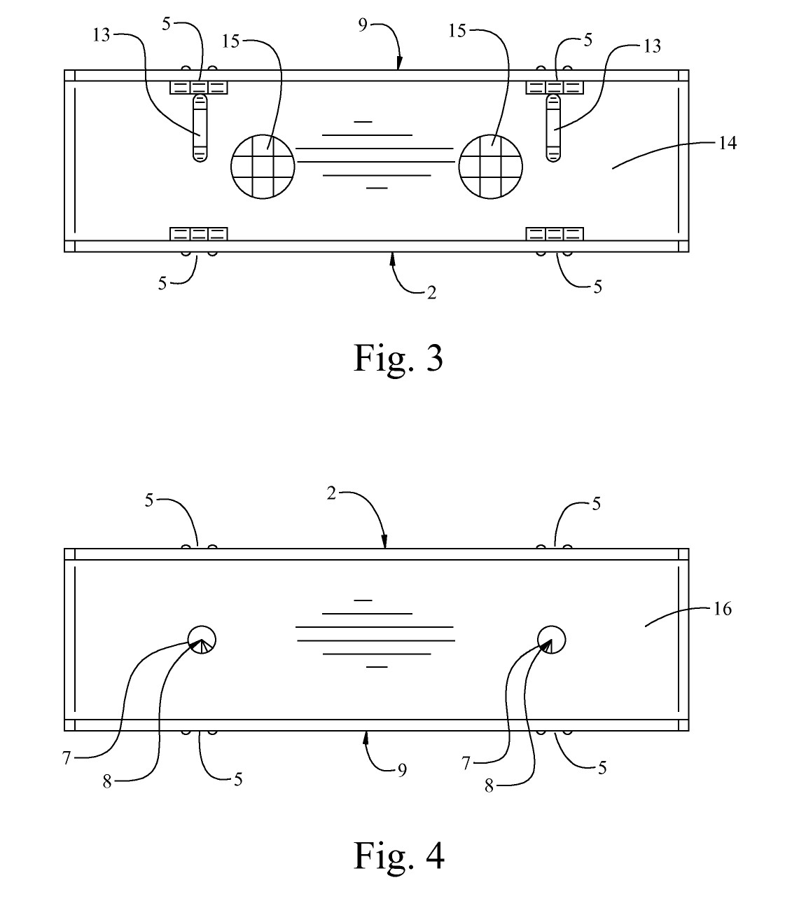

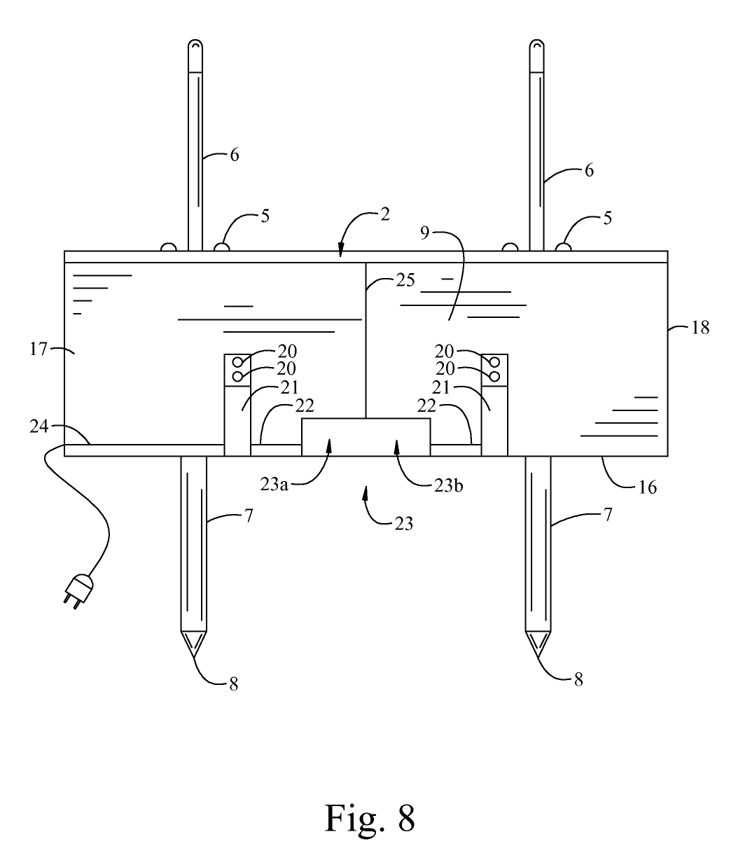

FIG. 3 then shows the invention from the top, that is, above the indicia shown in FIG. 1. The invention has the top of the housing, as at 14, to which connects the hinges 5, here shown as four, two for each cover, and the hooks 6 here showing their bights 13. The top of the housing has a generally rectangular shape with a depth that spaces apart the front cover 2 and the rear cover 9. The top of the housing 14 also includes an alternate embodiment of at least one solar cell 15, here shown as two. The solar cells, locating inwardly from the hooks, capture ambient sunlight falling upon them and create direct current that supplies the illumination for the indicia directly and for charging of at least one battery, later shown in FIG. 8. The solar cells are wired into the electrical system of the invention.

Opposite FIG. 3, FIG. 4 shows the bottom of the invention, generally opposite the hooks and the hinges. The housing has its bottom as at 16, generally rectangular and spaced apart from the top of the housing 14 previously shown. Generally the bottom 16 and the top 14 are parallel and form a box like is shape when the covers 2, 9 are closed upon the housing as in FIGS. 1, 2. The bottom 16 provides attachment points for the spikes 7. The attachment points are generally threaded holes in the bottom 16 that receive a threaded end of a spike opposite the tips 8 shown here.

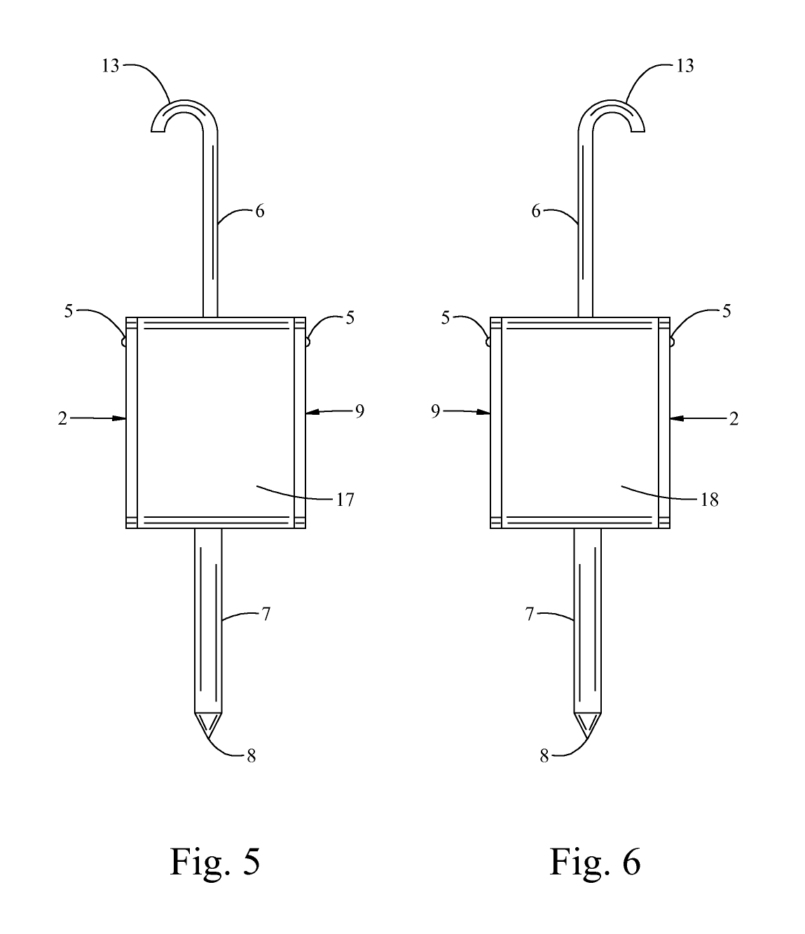

Turning the invention again, FIG. 5 shows the right end of the invention. The invention has a right wall of the housing as at 17 that joins with the top 14 and the bottom 16. The right wall 17 is generally rectangular, and often square in shape. The right wall is slightly recessed from the front cover 2 and the rear cover 9, that is, the covers are slightly longer than the right wall. The overlap in cover length prevents intrusion of moisture within the invention.

And opposite FIG. 5, FIG. 6 shows the left end of the invention with a left wall of the housing as at 18. Similar to the right wall, the left wall 18 has a rectangular shape occasionally made square. The covers 2, 9 also overlap the left wall in length preventing moisture intrusion.

From time to time, a user may require access to the interior of the invention. FIG. 7 shows the invention with the front cover 2 and the rear cover 9 opening. The covers hingedly connect to a housing 19 at the top 14 of the housing. The housing has its bottom 16 opposite and beneath the top 14 and its ends a left end 18 shown and the opposite right end not shown in this figure. The bottom, top, left end, and right end cooperate to form a box like shape, generally rectangular. The front cover 2 opens outwardly and upwardly from the top on hinges 5 towards the hooks. As in FIG. 1, the front cover has various indicia 4 thereon. The indicia are preferably transparent with the remainder of the front cover as opaque. Each indicia has a retro reflective tape outline as previously described. The rear cover 9 also opens outwardly, that is away from the front cover upon its hinges 5. The top 14 of the housing provides the attachment points for the hooks 6. The hooks generally have a threaded connection to the top. The bights 13 of the hooks, outwardly from the top 14, extend towards the is rear cover. Upon hanging the bights upon a window frame, door, door panel, or other line, the rear cover faces away from any person viewing the invention. And the bottom 16 allows the housing to receive two spikes 7, generally spaced apart that permit ground level installation of the invention. The spikes have tips 8 that ease embedment of the spikes into the ground.

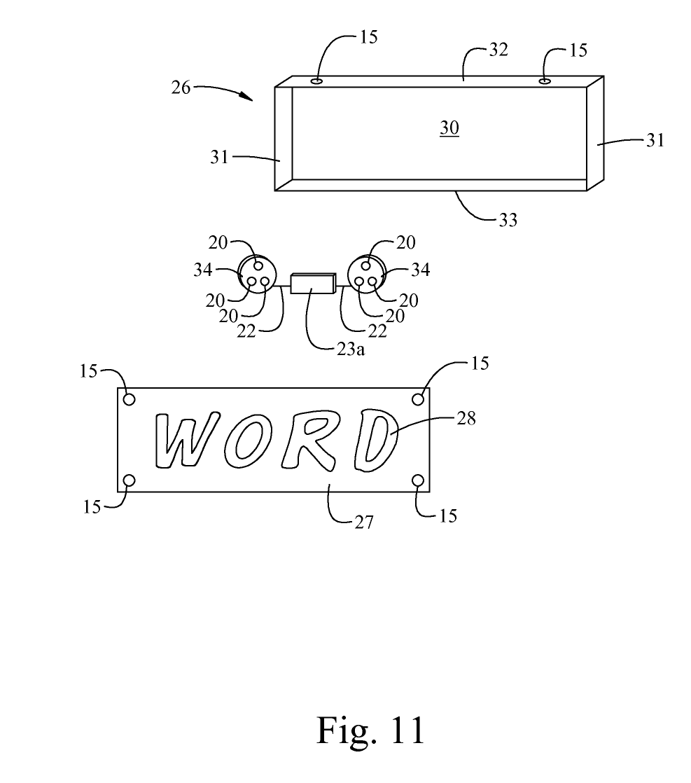

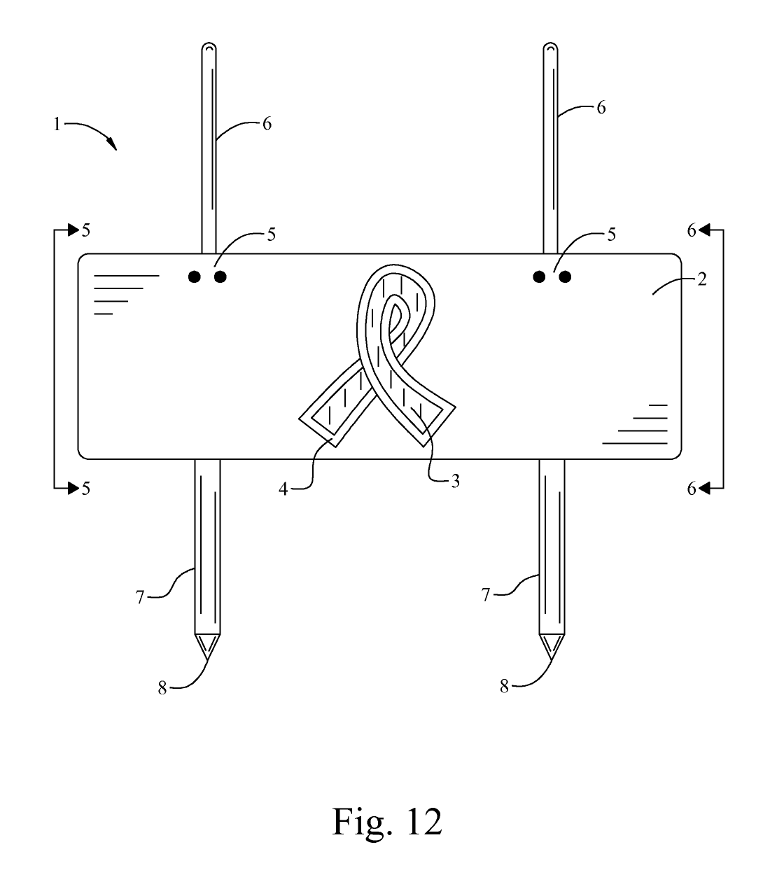

The previous figures have shown the invention as seen by a person viewing it in the closed position. From time to time, the invention can be opened as shown in FIG. 8. FIG. 8 shows a front view of the invention 1 with the front cover 2 lifted upon its hinges 5 upwardly towards the hooks 6. The front cover pivots upwardly to become generally coplanar with the top 14. The housing has its interior shown in this figure bounded by the right end 17, the bottom 16, the left end 18 and the rear cover 9 in the background. Within the interior of the invention, the invention provides for direct illumination of the indicia included upon the front cover 2. The illumination comes from at least one light emitting diode 20, or LED, here shown as two spaced apart pairs. The LEDs have positions behind the front cover, generally spaced inwardly from the ends for even illumination of the indicia. The LEDs are preferably yellow in color with the front cover being black. The yellow LEDs have a lesser cost than other colors of LED. An LED that appears white in color generally blends the light from other colors of LED, such as red, green, and bulb where the usage of multiple colors increases the cost proportionally. Though this figure shows two pairs of LED, the Applicant foresees an alternate embodiment where the indicia take their form from strips of LED formed into the shapes of letters, numerals, and select designs. The LED generally rest upon stands 21 that spaced them upwardly from the bottom 16 for even illumination in the vertical direction. The LEDs receive direct current via wiring 22 in communication with a power source 23. The power source includes a battery 23a or a transformer 23b that steps down utility service supplied via a cord 24. As described in FIG. 3, the invention may include solar is cells 15 upon the top. The solar cells provide direct current to the battery 23a through wiring 25 which allows for its recharge during daylight hours. As later described and shown in FIG. 11, additional components preserve battery life and regulate powered illumination of the invention during daylight in the preferred and alternate embodiments. These components also include a light sensor that detects the presence of sunlight and opens a switch preventing illumination of the lights, thus saving the battery. The light sensor also closes the switch during fog and inclement weather so that the alternate embodiment illuminates unlike during typical daylight hours. The components may also include a delayed off relay that extinguishes the light source gradually in the presence of sufficient sunlight as during daytime.

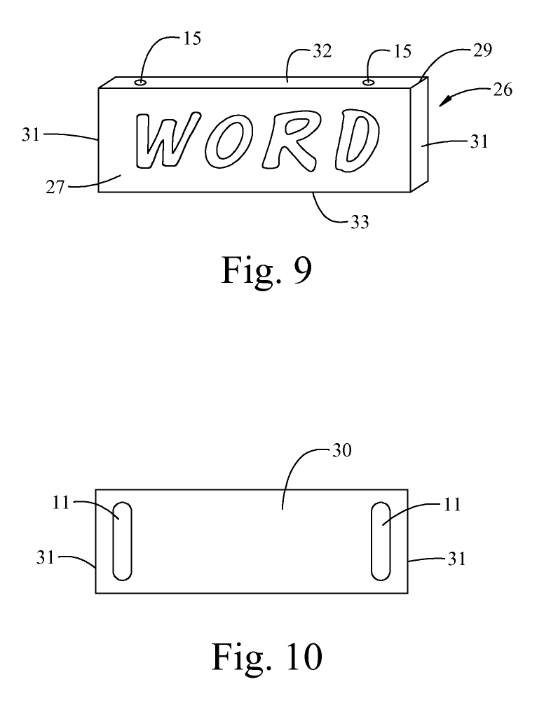

FIG. 9 shows an alternate embodiment of the invention for deployment upon a vehicle. This alternate embodiment has a case 26, generally rectangular in shape and thin in cross section, as at 29, suitable for application upon a vehicle. The case is thin enough to appeal to a driver's aesthetic sense and thick enough to contain the components of the invention as later shown. Being rectangular, the case has two lateral ends 31, a longitudinal top 32, and a longitudinal bottom 33 as shown. The top and bottom are mutually parallel and spaced apart, and perpendicular to the lateral ends. The lateral ends are generally lesser in length than the top and the bottom. The case has its front cover 27 having indicia 28 thereon being letters, numerals, or select designs. As above, the front cover 27 is generally opaque with preferably transparent indicia 28 therein and alternatively translucent indicia. The front cover generally does not overhang the remainder of the invention for less air resistance.

Opposite the front cover 27 of this alternate embodiment, FIG. 10 shows the rear cover 30 of the case. The rear cover is generally rectangular and opaque of generally similar dimensions as the front cover. The rear cover does not have any indicia thereon. The rear cover though has at least one vertical strip 11 that is secures the rear cover to a vehicle surface. Preferably, the rear cover has two vertical strips, mutually parallel and spaced apart, proximate each end 31 as shown. In the preferred embodiment, the vertical strips include an adhesive with a release layer thereon. For installation, the user removes the release layer and places the adhesive upon the vehicle. This adhesive grasps metal and fiberglass and holds the invention in place upon a moving vehicle. Similar to bumper strips, the adhesive allows the user to remove the invention later from the vehicle without leaving reside behind. In an alternate embodiment, the vertical strips utilize strips of magnetic material affixed to the rear cover and with sufficient strength to support the weight of the invention from a ferrous metal surface, such as a vehicle body panel or bumper. The sizes of the vertical strips can be adjusted to provide a strong enough magnetic force to withstand the weight of the invention and wind forces encountered when a vehicle moves at highway speeds. In a further alternate embodiment, the rear cover has adhesive upon its entire surface covered in a release layer that the user removes for installation of the alternate embodiment upon a vehicle.

FIG. 11 shows an exploded view of the alternate embodiment. The case 26 is generally hollow defined by the rear cover 30, the top 32, the bottom 33, and the ends 31 similar to a thin box. The top includes at least one solar cell 15, here shown as two. The case has approximate dimensions of three inches by seven inches and a thickness of ⅜ inches or less. As shown in the figure, outwardly from the case, the invention includes at least one light 34, here shown as two for redundancy in the rugged vehicle environment. Each light has at least one LED 20 as previously described. Preferably, each light has three LED equally spaced. The lights receive direct current via wiring 22 from a battery 23a. The battery has a similar shape and construction as a battery for a cellular telephone. The battery can be recharged from exterior electrical supply of appropriate voltage, generally 12 volts, the vehicle's electrical system if desired by the driver, and by solar cells. Proximate the battery, this alternate embodiment includes additional components 34 that preserve battery life and heighten convenience for a driver. These components include an accelerometer 34a, or inertial switch, that detects when the vehicle has stopped and a relay 34b that turns the lights off after a predetermined time such as two minutes after the vehicle stops. These two components turn off the alternate embodiment, particularly its light, without attention of the driver. These components also include a light sensor 34c that detects the presence of sunlight and opens a switch preventing illumination of the lights, thus saving the battery. The light sensor also closes the switch during fog and inclement weather so that the alternate embodiment illuminates. And forward of the lights, battery, and components, this figure shows the front cover 27 with indicia 28 thereon. Alternatively, the front cover also includes a plurality of solar cells, 15, generally locating proximate the corners of the front cover outwardly from the indicia. The solar cells provide direct current via wiring to the battery as previously described.

And FIG. 12 describes a further alternate embodiment of the invention. This alternate embodiment has a similar housing, front cover, and rear cover and illumination means as described above and shown in FIG. 1. This alternate embodiment though has indicia 3 upon its front cover 2 having a ribbon like form in a figure eight shape with the lower portion of the shape truncation. Such ribbons have become popular in recent years for various worthy and charitable causes.

From the aforementioned description, an illuminated sign with supports. The illuminated sign with supports is uniquely capable of securing to a building, a vehicle, or the ground upright while providing reflective and direct illumination. The illuminated sign with supports allows for various transparent indicia placed upon or within an opaque cover, including letters, numerals, graphics, and designs. The illuminated sign with supports and its various components may be is manufactured from many materials, including but not limited to, brass, bronze, steel, aluminum, polymers, polyvinyl chloride, high density polyethylene, polypropylene, light emitting diodes, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. An apparatus presenting a message visible during day, night, and inclement weather, said apparatus capable of being upright upon the ground or of being suspended upright from a building, vehicle, or component thereof, said apparatus comprising:
a hollow housing having a top, an opposite bottom, a left end and a spaced apart right end wherein said left end and said right end span from said top to said bottom;
a front cover hingedly connecting to said top, said front cover including indicia, said indicia allowing passage of light there through, and said front cover outwardly of said indicia being opaque;
a rear cover hingedly connecting to said top opposite said front cover, said rear cover being opaque;
is at least one light source, locating within said housing and behind said front cover;
a power source having electrical communication to said at least one light source; and,
means to regulate said at lease one light source as operating during night, fog, and inclement weather.

2. The message apparatus of claim 1 further comprising:
at least one hook connecting to said top, said at least one hook capable of securement to a building, vehicle, or component thereof;
at least one spike extending beneath said bottom;
at least one strip upon said rear cover, said at least one strip capable of releasable securement to a building, vehicle, or component thereof; and,
said indicia being one of transparent or translucent.

3. The message apparatus of claim 2 wherein said indicia are transparent.

4. The message apparatus of claim 1 further comprising:
said at least one light source is one of incandescent bulb or light emitting diode.

5. The message apparatus of claim 4 further comprising:
said at least one light source is a light emitting diode.

6. The message apparatus of claim 5 wherein said at least one light source is yellow.

7. The message apparatus of claim 5 further comprising:
two pairs of light emitting diodes.

8. The message apparatus of claim 1 further comprising:
said power source being one of battery, utility service, or solar cell.

9. The message apparatus of claim 1 further comprising:
said power source including at least one battery and at least one solar cell is in electrical communication with said at least one battery.

10. The message apparatus of claim 1 wherein said regulating means includes a light sensor and a delayed off relay, said delayed off relay interrupting supply of electricity to said at least one light source upon said light sensor detecting the incidence of daylight upon said apparatus.

11. The message apparatus of claim 1 further comprising:
said at least one strip being one of adhesive or magnetic capable of securement of said apparatus to a building or a vehicle.

12. The message apparatus of claim 11 further comprising:
at least one vertical strip generally parallel to said left end and said right end; and,
at least one horizontal strip generally parallel to said top and to said bottom.

13. The message apparatus of claim 12 further comprising two vertical strips and one horizontal strip, said horizontal strip locating between said vertical strips.

14. An apparatus presenting a message visible during day, night, and inclement weather, said apparatus capable of being upright upon a vehicle or component thereof, said apparatus comprising:
a hollow case having a top, an opposite bottom, a left end and a spaced apart right end wherein said left end and said right end span from said top to said bottom;
a front cover releasably connecting to said case, including indicia, said indicia allowing passage of light there through, and said front cover outwardly of said indicia being opaque;
a rear cover opposite said front cover, said rear cover being opaque;
at least one strip upon said rear cover, said at least one strip capable of releasable securement to a vehicle or component thereof;
is at least one light source, locating within said case and behind said front cover;
a power source locating within said case and having electrical communication to said at least one light source; and,
means to regulate said at lease one light source as operating during night, fog, and inclement weather.

15. The message apparatus of claim 14 wherein said indicia are transparent.

16. The message apparatus of claim 14 further comprising:
said at least one light source being a light emitting diode.

17. The message apparatus of claim 16 wherein said at least one light source is yellow.

18. The message apparatus of claim 1 further comprising:
said power source being one of battery or solar cell.

19. The message apparatus of claim 14 wherein said regulating means includes a light sensor, a motion sensor, and a delayed off relay, said motion sensor adapting to detect the motion of the vehicle, said delayed off relay interrupting the supply of electricity to said at least one light source upon said light sensor detecting the incidence of daylight upon said apparatus, and said delayed off relay interrupting the supply of electricity to said at least one light source upon said motion sensor detecting the absence of motion of the vehicle.

20. The message apparatus of claim 14 further comprising:
said at least one strip being one of adhesive or magnetic capable of securement of said apparatus to a vehicle and capable of avoiding damage to the vehicle.
